(19) United States
(12) Patent Application Publication
(10) Pub. No.: US 2015/0161320 A1
(43) Pub. Date: Jun. 11, 2015

(54) SCATTERING BAR OPTIMIZATION APPARATUS AND METHOD

(71) Applicant: Spansion Inc., Sunnyvale, CA (US)

(72) Inventor: Xiaohai Li, Santa Clara, CA (US)

(73) Assignee: Spansion Inc., Sunnyvale, CA (US)

(21) Appl. No.: 14/100,673

(22) Filed: Dec. 9, 2013

(51) Int. Cl. G06F 17/50

(52) U.S. Cl. CPC G06F 17/5081

(57) ABSTRACT

A computer-implemented method is disclosed for optimizing one or more sub-resolution assist features for use in a photolithographic process. The method may include incorporating a sub-resolution assist feature within a virtual photomask. The virtual photomask may then be modeled to produce a virtual print. One or more intensity values corresponding to the sub-resolution assist feature may be collected from the virtual print. Based on the one or more intensity values, a probability of having been printed may by assigned to the sub-resolution assist feature. In an iterative process, the probability may be used to optimize at least one of a location and size of the sub-resolution assist feature.

### BACKGROUND

1. Field of the Invention

This invention relates to photolithography and more particularly to systems and methods for optimizing the use of one or more sub-resolution assist features within a photomask.

2. Background of the Invention

Photolithography is currently an important process in the manufacture of semiconductors. To adapt photolithography to the demands of modern semiconductors, various enhancement techniques have been introduced. However, due to the physics involved, certain such techniques are difficult to optimize. Accordingly, what is needed are systems and methods for optimizing selected enhancement techniques used in photolithography.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram of exemplary features and patterns that may be used in a photolithographic process in accordance with the present invention;

FIG. 2 is a schematic block diagram of one embodiment of a photolithographic process or method in accordance with the present invention;

FIG. 3 is a schematic block diagram showing how a virtual photolithographic process may be calibrated to model an actual photolithographic process in accordance with the present invention;

FIG. 4 is a schematic diagram of an exemplary optimized pattern in accordance with the present invention;

FIG. 5 is a schematic diagram of exemplary sub-resolution assist features being used in conjunction with an isolated feature in accordance with the present invention;

FIG. 6 is a schematic diagram of an exemplary process window that may be associated with a photolithographic process;

FIG. 7 is a schematic diagram of an exemplary process window that may be associated with a photolithographic process enhanced by one or more sub-resolution assist features;

FIG. 8 is a schematic diagram showing the “printing” that may be associated with sub-resolution assist features;

FIG. 9 is a schematic block diagram of one embodiment of a computer system in accordance with the present invention;

FIG. 10 is a schematic block diagram of one embodiment of a photomask optimization system in accordance with the present invention;

FIG. 11 is a schematic block diagram of one embodiment of a method for optimizing a photomask in accordance with the present invention;

FIG. 12 is a schematic block diagram of one embodiment of a method for determining whether further improvement of a photomask is needed in accordance with the present invention;

FIG. 13 is a schematic diagram showing various sampling methodologies or patterns that may be employed in accordance with the present invention;

FIG. 14 is a graphical representation of one embodiment of a printability model in accordance with the present invention; and

FIG. 15 is a formulaic illustration showing one embodiment of an optimization method for generating a printability model in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

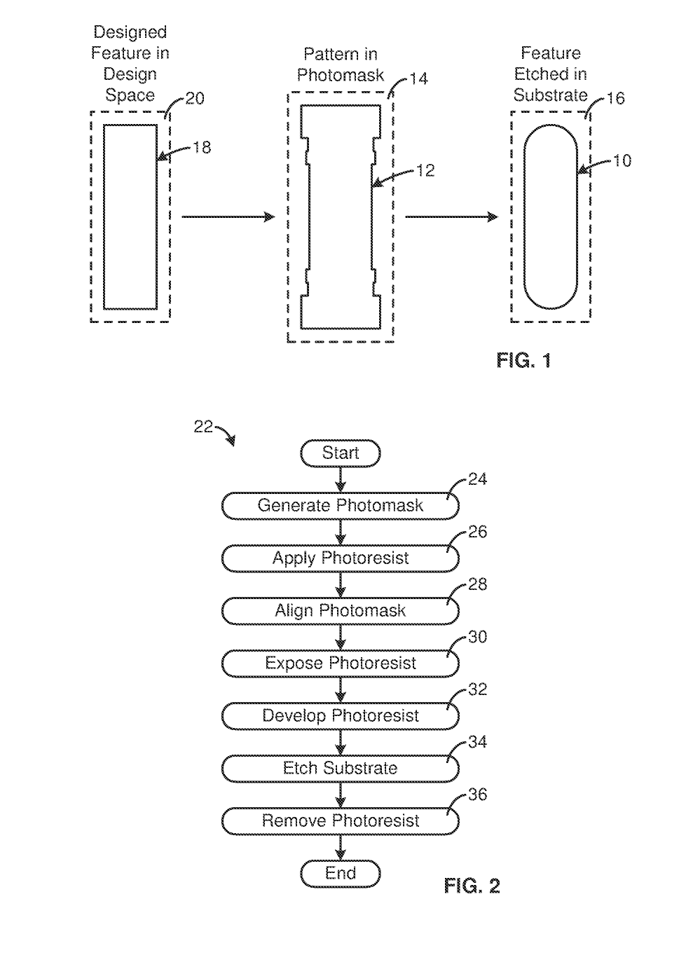

Referring to FIGS. 1 and 2, an integrated circuit (also known as a monolithic integrated circuit, chip, or a microchip) may be defined as a set of electronic circuits that reside on a small plate or “chip” of semiconductor material. In the modern world, integrated circuits are ubiquitous. They can be found in products ranging from home appliances to mobile telephones.

One key advantage of integrated circuits is that they can be very compact. For example, an integrated circuit having up to several billion transistors and other electronic components may fit in an area the size of a fingernail. With advances in technology, the widths of conducting lines within integrated circuits have been getting smaller and smaller. For example, in the year 2008, line widths dropped below 100 nanometers. In the year 2013, line widths are expected to be in the tens of nanometers.

This trend toward smaller and smaller line widths has, to a significant degree, been the result of improvements in the photolithographic process used to etch features 10 defining such lines. Photolithography (also known as optical lithography or UV lithography) may be defined as a process that uses light to transfer a geometric pattern 12 from a photomask 14 to a light-sensitive chemical “photoresist” supported on a substrate 16. Accordingly, in a design process, the various features 18 of an integrated circuit may be designed, created, or defined in a virtual space 20. However, it is in a photolithographic process 22 that the designed features 18 become etched features 10 on a substrate 16.

A photolithographic process 22 in accordance with the present invention may have any suitable steps. In selected embodiments, a photolithographic process 22 may include generating 24 of a photomask 14 having patterns 12 formed therein. Such generating 24 may include optimizing a photomask 14 to reproduce, as well as possible, the designed features 18 in the etched features 10.

A photolithographic process 22 may further include applying 26 a photoresist material to a substrate 16. Once the photoresist has cured, dried, or the like, the photomask 14 may be aligned 28 with the substrate 16. Accordingly, the patterns 12 of the photomask 14 may define which portions of the photoresist are exposed 30 to light and which are not. This exposure 30 to light may cause a chemical change that allows some of the photoresist to be removed by a special solution. Thus, after the exposure 30, the photoresist may be developed 32 by applying the solution thereto.

After the photoresist has been developed 32, a chemical agent may be used to etch 34 the substrate 16. During such etching 34, the chemical agent may remove the uppermost layer of the substrate 16 in the areas that are not protected by the photoresist. Once the etching 34 has been completed, the remaining photoresist may be removed 36. The etched substrate 16 may then be ready for further processing consistent with the manufacture of an integrated circuit.

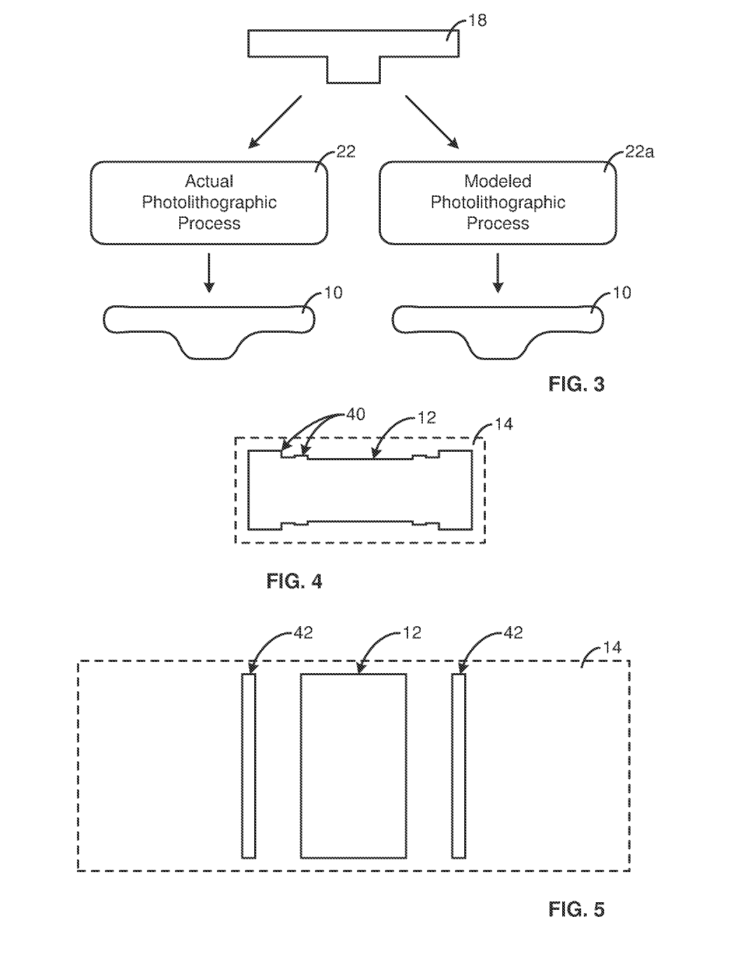

Referring to FIG. 3, due to the laws of physics, process errors, and the like, a photolithography process 22 may not produce etched features 10 that exactly match the designed features 18. For example, the laws of physics may limit the ability of light to pass the edge placement integrity of very small designed features 18 to corresponding etched features 10. Accordingly, an etched feature 10 may include or have irregularities such as rounded corners and/or line widths that are narrower or wider than designed.

In selected embodiments, a computer system in accordance with the present invention may include, implement, or utilize a modeling module that selectively conducts a modeled photolithographic process 22a. A modeling module and corresponding modeled photolithographic process 22a may enable such a computer system to efficiently and economically improve or optimize a photomask 14. An improved or optimized photomask 14 may better reproduce the designed features 18 in corresponding etched features 10.

That is, given one or more designed features 18, a properly calibrated modeling module may use a virtual version of a photomask 14 in a modeled photolithographic process 22a to produce one or more virtual etchings 10 that match what an actual photolithographic process 22 would produce using an actual version of the photomask 14. Additionally, in selected embodiments, a modeling module may iteratively conduct a modeled photolithographic process 22a while adjustments are made to a photomask 14 at issue. This may enable the computer system to identify which adjustments better reproduce the original designed features 18 in the virtual etchings 10. Once a virtual photomask 14 has been optimized, it may be used to inform, guide, or dictate the generation 24 of an actual photomask 14.

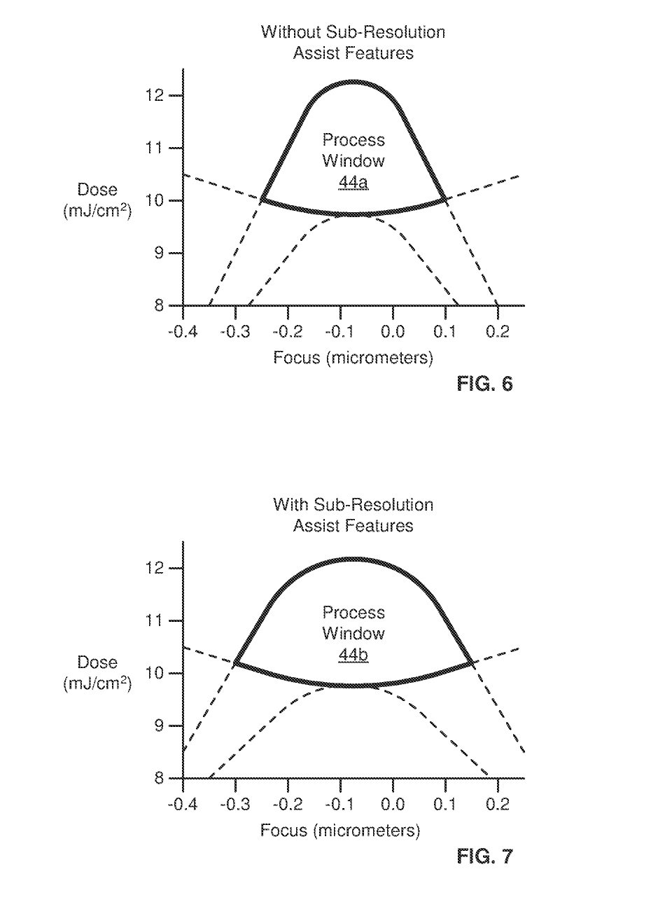

Referring to FIGS. 4-7, a computer system may improve or optimize various aspects of a virtual photomask 14 (and hence, various aspect of any actual photomask 14 based on the virtual photomask 14). For example, in selected embodiments, a computer system may seek to improve or optimize the line widths and/or shapes of one or more etched features 10. This may be done by moving edges or adding extra polygons 40 to the patterns 12 of a photomask 14. One or more critical dimensions measured from the resulting etched features 10 may be used to improve or optimize such adjustments to the edges of the patterns 12.

Alternatively, or in addition thereto, a computer system may seek to improve or optimize the location, size, or the like of one or more sub-resolution assist features 42. Sub-resolution assist features 42 may be included within a photomask 14 to minimize or eliminate differences in the proximity effects between isolated and densely-packed edges of main features in a photolithographic process 22. Main features may be defined as features that are intended to be “printed” or etched on a substrate 16. In contrast, sub-resolution assist features 42 may be included to enhance main features, but are not intended to be printed or etched themselves. Scattering bars 42 are an example of sub-resolution assist features 42 in accordance with the present invention.

In selected embodiments, sub-resolution assist features 42 may be positioned in a photomask 14 next to isolated edges of one or more patterns 12 to match the edge intensity produced by the isolated edges to that produced by one or more densely packed edges. This may enable an etched feature 10 (e.g., main feature) having at least one isolated edge to have nearly the same width as an etched feature 10 (e.g., main feature) having densely packed edges. It may also increase or maximize a process window 44 associated with such features 10.

A process window 44 may be analogized to a mechanical tolerance. A larger mechanical tolerance may lower the effort and expense associated with the manufacture of a particular part. Similarly, a larger process window 44 may lower the effort and expense (e.g., increase the yield) associated with a photolithographic process 22. Since a process window 44b for a photomask 14 with sub-resolution assist features 42 may be larger than a process window 44a for a photomask 14 without sub-resolution assist features 42, the photomask 14 with the sub-resolution assist features 42 may be preferred in certain situations or embodiments.

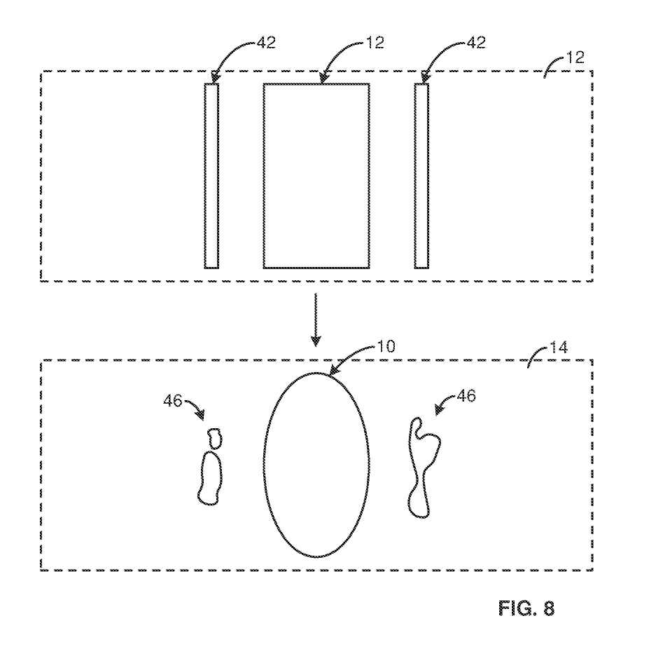

Referring to FIG. 8, sizes and locations for sub-resolution assist features 42 may be selected by conducting experiments. However, these experiments are typically conducted in the context of actual photolithographic processes 22. Accordingly, they are expensive and time-consuming to perform.

Additionally, optimization techniques that may be suitable for adjustments 40 to the edges of patterns 12 may not be suitable for optimizing the size, location, and the like for sub-resolution assist features 42. Sub-resolution assist features 42 are not intended to be etched themselves. If a sub-resolution assist feature 42 “prints” (i.e., produces its own etching 46), the resulting etching 46 is typically not well defined and is considered to be a flaw (e.g., a fatal flaw). Critical dimensions of such etchings 46 typically cannot be measured accurately. Thus, optimization techniques that rely on critical dimensions may not be suitable for optimizing the size, location, and the like for sub-resolution assist features 42. Accordingly, computer systems in accordance with the present invention may optimize the size, location, and the like for sub-resolution assist features 42 without relying on any critical dimensions thereof.

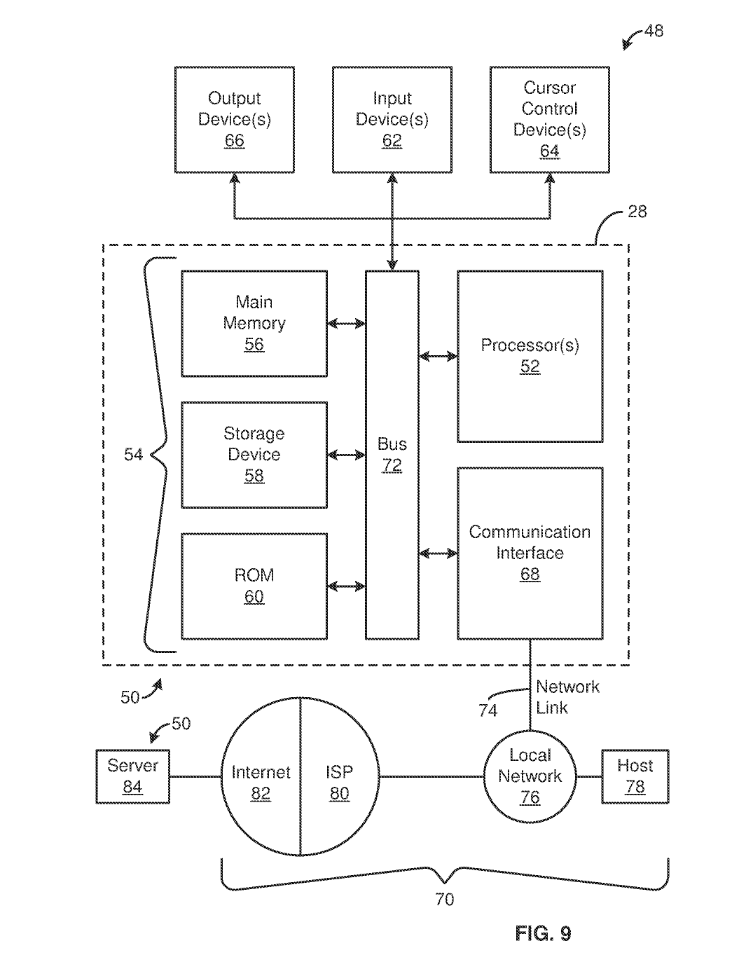

Referring to FIG. 9, a computer system 48 in accordance with the present invention may provide, enable, or support the optimization of a photomask 14 in any suitable manner. In certain embodiments, a computer system 48 may be embodied as hardware, software, or some combination thereof. For example, in selected embodiments, a computer system 48 may include one or more nodes 50.

A node 50 may include one or more processors 52, processor cores 52, or central processing units (CPUs) 52 (hereinafter “processors 52”). Each such processor 52 may be viewed an independent computing resource capable of performing a processing workload distributed thereto. Alternatively, the one or more processors 52 of a node 50 may collectively form a single computing resource. Accordingly, individual workload shares may be distributed to nodes 50, to multiple processors 52 of nodes 50, or combinations thereof.

In selected embodiments, a node 50 may include memory 54. Such memory 54 may be operably connected to a processor 52 and include one or more devices such as main memory 56, a hard drive or other non-volatile storage device 58, read-only memory (ROM) 60, random access memory (RAM), or the like or a combination or sub-combination thereof. In selected embodiments, such components 52, 54, 56, 58, 60 may exist in a single node 50. Alternatively, such components 52, 54, 56, 58, 60 may be distributed across multiple nodes 50.

In selected embodiments, a node 50 may include one or more input devices 62 and/or cursor control devices 64 such as a keyboard, mouse, touch screen, scanner, memory device, communication line, and the like. A node 50 may also include one or more output devices 66 such as a monitor, output screen, printer, memory device, and the like. A node 50 may include a communication interface 68 in the form of a network card, port, or the like to facilitate communication through a computer network 70. Internally, one or more busses 72 may operably interconnect various combinations or sub-combinations of components 52, 54, 56, 58, 60, 62, 64, 66, 68 to provide communication therebetween. In certain embodiments, various nodes 52 of a system 48 may contain more or less of the components described hereinabove.

In selected embodiments, a communication interface 68 may provide or support external, two-way data communication to or via a network link 74. For example, a communication interface 68 may be a wireless network interface controller or a cellular radio providing a data communication connection. Alternatively, a communication interface 68 may comprise a local area network (LAN) card providing a data communication connection to a compatible LAN. In any such embodiment, a communication interface 68 may send and receive electrical, electromagnetic, or optical signals conveying information.

A network link 74 may provide data communication through one or more networks to other computing devices (e.g., others devices contained within a computing environment). For example, a network link 74 may provide a connection through a local network 76 of a host computer 78 or to data equipment operated by an Internet Service Provider (ISP) 80. An ISP 80 may, in turn, provide data communication services through the Internet 82. Accordingly, a node 50 may send and receive commands, data, or combinations thereof, including program code, through one or more networks 76, 82, a network link 74, and communication interface 68. Thus, one node 50 may interface or otherwise communicate with a remote node 50 (e.g., server 84). Instructions received by a node 50 may be executed by a processor 52 as they are received, stored for later execution (e.g., stored on a storage device 58), or some combination thereof.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on one or more master nodes 50, worker nodes 50, or combinations thereof. In selected embodiments, one or more master and/or worker nodes 50 may be positioned remotely with respect to one another. Accordingly, such nodes 50 may be connected to one another through any type of network, including a local area network (LAN) or a wide area network (WAN), or the connection may be made through the Internet 82 using an Internet Service Provider 80.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Selected embodiments in accordance with the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

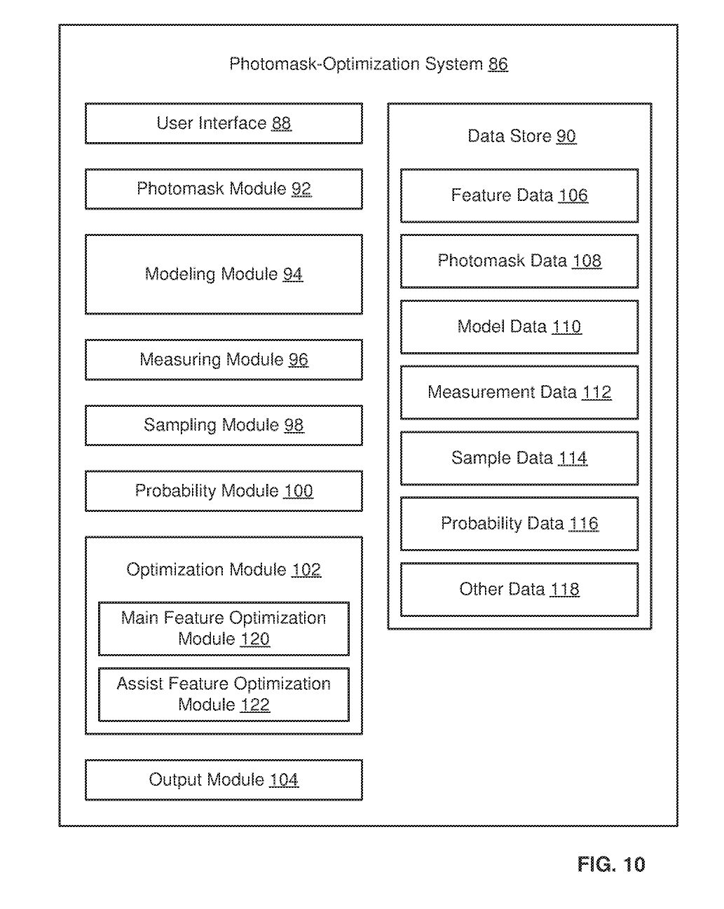

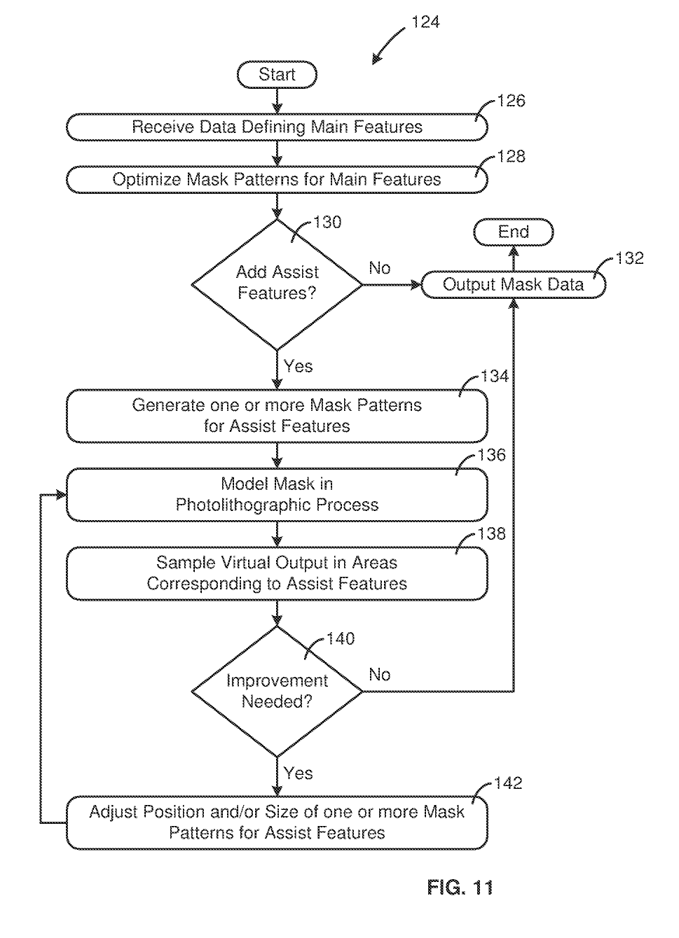

Referring to FIG. 10, in certain embodiments, a photomask-optimization system 86 may operate on or within a computer system 48 to enable, support, or conduct two optimization phases or processes. In a first, build phase or process, a photomask-optimization system 86 (or selected portions thereof) may enable, support, or conduct the creation and optimization of a printability model. A printability model may accurately and reliably correlate intensity data collected from a virtual print output by a modeled photolithographic process 22a to a probability that one or more corresponding sub-resolution assist features 42 will print in an actual photolithographic process 22. In a second, application phase or process, a photomask-optimization system 86 may use a printability model to optimize one or more photomasks 14.

For example, a photomask-optimization system 86 may use a printability model to optimize the size and/or placement of one or more sub-resolution assist features 42. In certain embodiments, this may be done by shrinking a sub-resolution assist feature 42 until a probability of printing for the sub-resolution assist feature 42 is substantial zero. To optimize the placement of a sub-resolution assist feature 42, the sub-resolution assist feature 42 may be moved until a predicted process window variation has been minimized.

In selected embodiments, the nature of the hardware and/or software of a computer system 48 in accordance with the present invention may reflect the specific processing to be supported or performed thereby. For example, a computer system 48 may be configured to be, provide, store, enable, support, and/or run a photomask-optimization system 86. Accordingly, a computer system 48 may be configured to be, provide, store, enable, support, and/or run a user interface 88, data store 90, photomask module 92, modeling module 94, measuring module 96, sampling module 98, probability model 100, optimization module 102, output module 104, one or more other modules as desired or necessary, or the like or some combination or sub-combination thereof.

A user interface 88 may enable and/or support interaction between one or more users and a photomask-optimization system 86. Different user interfaces 88 may support users of different types. For example, one user interface 88 may support one or more builders of the system 86, maintainers of the system 86, or the like, while another user interface 88 may support one or more users of the system 86.

A data store 90 may contain information supporting the operation of a photomask-optimization system 86. In selected embodiments, a data store 90 may contain or store data needed and/or generated by various components of a photomask-optimization system 86. For example, a data store 90 may contain feature data 104 defining one or more designed features 18 and the relative positioning therebetween. In certain embodiments, a photomask module 92 may use such feature data 106 to create a photomask 14. A data store 90 may also store photomask data 108 defining one or more photomasks 14 and/or patterns 12 thereof, model data 110 enabling a modeling module 94 to conduct a modeled photolithographic process 22a and/or defining the outputs of a modeled photolithographic process 22a, measurement data 112 such as critical dimensions collected from selected features 10, sample data 114 collected from a virtual print output by a modeling module 94, probability data 116 characterizing the probability that one or more sub-resolution assist features 42 have or will print, other data 118 as desired or necessary, or the like or some combination or sub-combination thereof. In selected embodiments, probability data 116 may comprise or define a printability model.

A photomask module 92 may be programmed to perform any desired functions with respect to one or more photomasks 14. For example, a photomask module 92 may receive data 106 describing one or more designed features 18 and generate a photomask 14 corresponding thereto. A photomask module 92 may pass or feed data 108 describing or defining a photomask 14 to a modeling module 94. In selected embodiments, a photomask module 92 may implement changes to a photomask 14 as requested or instructed by an optimization module 102.

A modeling module 94 may model one or more processes and provide virtual outputs corresponding thereto. For example, as described hereinabove, a modeling module 94 may use a virtual version of a photomask 14 in a modeled photolithographic process 22a to produce a virtual print (e.g., a virtual version of one or more etched features 10) that matches an actual print that an actual photolithographic process 22 would produce using an actual version of the photomask 14. Additionally, a modeling module 94 may work in conjunction with one or more other components of a photomask-optimization system 86 (e.g., an optimization module 102) to iteratively conduct a modeled photolithographic process 22a as adjustments are made to a corresponding virtual photomask 14. This may enable a photomask-optimization system 86 to optimize various aspects of a photomask 14.

A measuring module 96 may receive, collect, communicate, generate, process, and/or use measurement data 112. For example, in selected embodiments, a measurement module 96 may enable, support, or conduct the measurement of certain dimensions one or more etched features 10 on a virtual print produced by a modeling module 94. Such dimensions may be or include critical dimensions of such etched features 10. According, in certain embodiments, a measurement module 96 may provide measurement data 112 that may be used by an optimization module 102 to optimize various aspects of a photomask 14 (e.g., optimize features having critical dimensions that can be accurately measured).

A sampling module 98 may collect, communicate, generate, process, and/or use sample data 114. For example, in selected embodiments, a sample module 98 may enable, support, or conduct the sampling of certain characteristics (e.g., intensity) of one or more locations on a virtual print produced by a modeling module 94. Such sample data 114 may be or include printing intensity for selected areas of a virtual print that correspond to one or more sub-resolution assist features 42. According, in certain embodiments, a sample module 98 may provide sample data 114 that may be used by an optimization module 102 to optimize various aspects of a photomask 14 (e.g., optimize features that lack critical dimensions that can be accurately measured).

A probability module 100 may receive, collect, communicate, generate, process, and/or use probability data 116. For example, in selected embodiments, a probability module 100 may enable, support, or conduct the conversion of selected sample data 114 into probability data 116 reflecting how likely it is that one or more sub-resolution assist features 42 will print. In certain embodiments, a probability module 100 may accomplish this at least in part by applying a printability model to sample data 114.

An optimization module 102 may optimize various aspects of a photomask 14. An optimization module 102 may accomplish this in any suitable manner. For example, in selected embodiments, an optimization module 102 may maximize or minimize a real function by systematically choosing input values from within an allowed set and computing the value of the function. Accordingly, an optimization module 102 may find the best available values of some objective function given a defined domain.

In certain embodiments, an optimization module 102 may optimize one or more main features within a photomask 14, as well as one or more sub-resolution assist features 42 within the photomask 14. The processes for optimizing such different features may themselves be different. Accordingly, an optimization module 102 may include a main feature optimization module 120, as well as an assist feature optimization module 122. In selected embodiments, an optimization module 102 may utilize such modules 120, 122 in finding the best available values of multiple objective functions given multiple domains.

An output module 104 may generate, collect, compile, send, communicate, and/or process any outputs of a photomask-optimization system 86. For example, in selected embodiments, an output module 104 may receive or collect photomask data 108 defining a virtual version of an optimized photomask 14. The output module 104 may then output such data 108 in a form that may be used in the manufacture of an actual version of the photomask 14.

Referring to FIG. 11, in selected embodiments, a method 124 performed by a photomask-optimization system 86 or one or more components thereof may begin when data 106 defining one or more main features is obtained or received 70. Sometime subsequent thereto, patterns 12 corresponding to the one or more main features 128 may be optimized 128. As part of that optimization 128 (or at some point therebefore or thereafter), a decision 130 may be made as to whether any sub-resolution assist features 42 are to be included within the photomask 14 at issue. If a decision 130 is made that no sub-resolution assist features 42 are to be included (e.g., that the photomask 14 has been or can be sufficiently optimized without sub-resolution assist features 42), then a system 86 may output 132 data 108 defining the optimized photomask 14 and the method 124 may end. Alternatively, if a decision 130 is make that sub-resolution assist features 42 are to be included, one or more patterns for sub-resolution assist features 42 may be generated 134 and incorporated within a photomask 14 as issue.

A photomask 14 may then be modeled 136. Such modeling 136 may produce a virtual output or print. Such output may identify, characterize, or represent what would be etched in a substrate 16 if the photomask 14 were used in an actual photolithographic process 22. The virtual output may be sampled 138 in the areas or locations corresponding to one or more sub-resolution assist features 42. In selected embodiments, such sampling 138 may comprise collecting intensity data 114 from the virtual output in the areas or locations corresponding to one or more sub-resolution assist features 42. In general, a higher intensity may be an indication that a corresponding sub-resolution assist features 42 printed. Conversely, a lower intensity may be an indication that the corresponding sub-resolution assist features 42 did not print.

Based at least in part on the data 114 collected in the sampling 138, a decision 140 may be made as to whether the photomask 14 needs improvement (i.e., has not yet reached an optimal condition). If a decision 140 is made that no improvement is needed, then a system 86 may output 132 data 108 defining the optimized photomask 14 and the method 124 may end. Alternatively, if a decision 140 is make that improvement is needed, the position and/or size or the like of one or more patterns for sub-resolution assist features 42 may be adjusted 142 and certain steps may be repeated with the newly adjusted photomask 14. Accordingly, a method 124 may continue until a photomask 14 has been optimized for both main features and sub-resolution assist features 42.

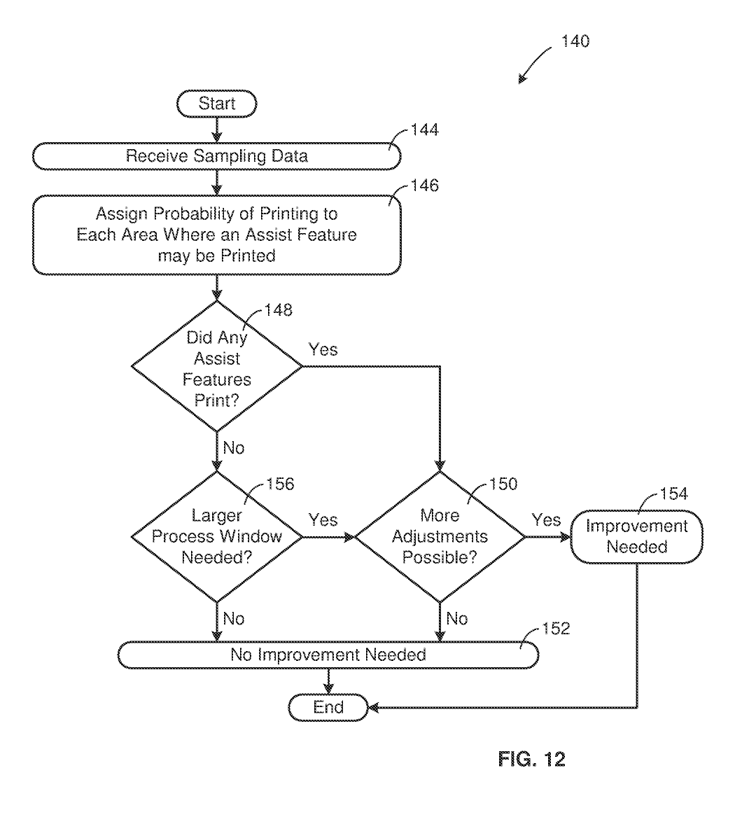

Referring to FIG. 12, a decision 140 as to whether improvement is needed may be made in any suitable manner. In selected embodiments, such a decision 140 may be or comprise a method having multiple steps. For example, the decision 140 may include receiving 144 sampling data 114 and using a printability model to assign 146 a probability value to each area or location where a sub-resolution assist feature 42 may print.

In selected embodiments, the probability values assigned 146 may be numbers selected from within a range. Alternatively, the probability values may be either a “yes” or a “no.” A “yes” may indicate that a sub-resolution assist feature 42 is likely to print in the corresponding area or location. Conversely, a “no” may indicate that a sub-resolution assist feature 42 is not likely to print in the corresponding area or location. Such an assignment 146 need not include the actual words “yes” or “no,” but may rely on any suitable binary mechanism (e.g., “0” and “1”) to indicate a first state or a second state, opposite the first state.

Subsequent to the assignment 146, a determination 148 may be made as to whether any sub-resolution assist features 42 did or are likely to print. If so, a first follow-up determination 150 may be made as to whether more adjustments of such sub-resolution assist features 42 are possible. If no further adjustments are possible (e.g., all input values from within an allowed set have been tried), then it may be concluded 152 that no further improvement is needed. Conversely, if further adjustments are possible (e.g., all input values from within an allowed set have not been tried), then it may be concluded 154 that further improvement is needed.

Alternatively, if it is determined 148 that no sub-resolution assist feature 42 did or is likely to print, a second follow-up determination 156 may be made. This second determination 156 may be whether a larger process window 44 is needed. If no larger process window 44 is needed (e.g., the process window for a photomask 14 or selected patterns 12 thereof has been maximized), then it may be concluded 152 that no further improvement is needed. Conversely, if a larger process window 44 is needed, then the first follow-up determination 150 may be encountered. As disclosed hereinabove, the first follow-up determination 150 may provide a check and only indicate or request further improvement when all input values from within an allowed set have not been tried.

The flowcharts in FIGS. 11 and 12 illustrate the architecture, functionality, and operation of possible implementations of systems, methods, and computer program products according to certain embodiments of the present invention. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

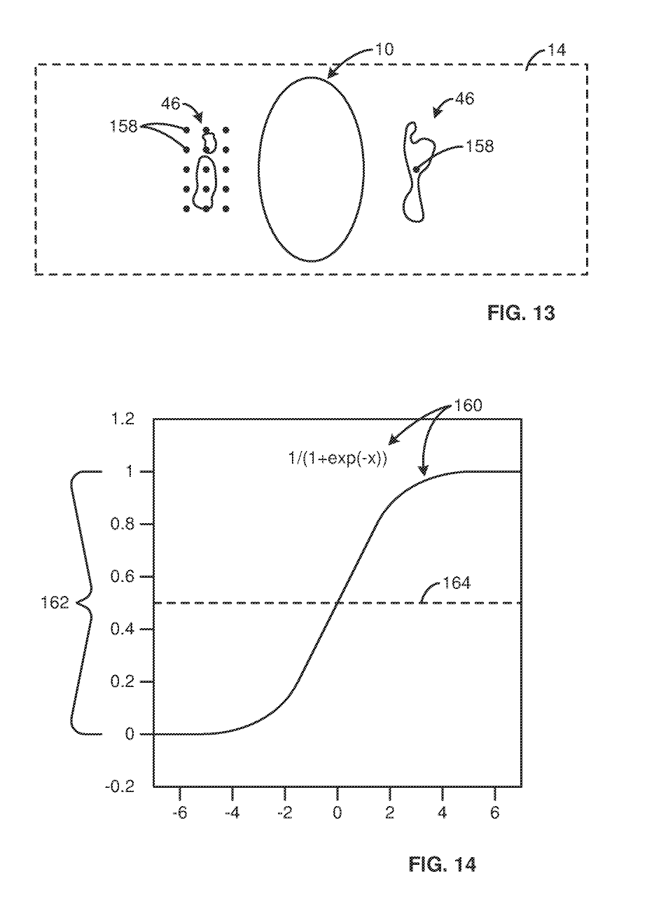

Referring to FIG. 13, a sampling module 98 may sample 138 a virtual output (e.g., a virtual version of an etched substrate 16 produced in a modeled photolithographic process 22a) in any suitable manner. In selected embodiments, a sampling module 98 may collect 138 multiple samples 158 corresponding to certain (e.g., each) sub-resolution assist features 42. For example, a sampling module 98 may collect 138 a two-dimensional array of samples 158 that is positioned over (e.g., centered over) an area or location corresponding to a sub-resolution assist feature 42.

In certain embodiments, each sample 158 of such an array may be used in an individual manner. In other embodiments, the samples 158 of an array may be used to determine some reduced set (e.g., one data point) representative of the information (e.g., intensity data) collected by the samples 158 forming the array. In still other embodiments, a sampling module 98 may collect 138 a single sample 158 corresponding to certain (e.g., each) sub-resolution assist feature 42. For example, a sampling module 98 may collect 138 a single sample 158 that is positioned over (e.g., centered over) an area or location corresponding to a sub-resolution assist feature 42.

Referring to FIG. 14, a probability module 100 may generate probability data 116 in any suitable manner. In selected embodiments, a probability module 100 may generate probability data 116 by referencing or using a printability model. In certain embodiments, a printability model may be, utilize, define, or comprise a function 160 having an output value within a certain range 162 (e.g., 0 to 1). Accordingly, when the function 160 is applied to printing intensity data 114 collected by a sample module 98, the intensity data 114 may be converted to a value within the range 162. A probability value within the range 162 may, therefore, be assigned to each sub-resolution assist feature 42.

In selected embodiments, a probability module 100 may assign probability values anywhere within a corresponding range. Alternatively, a probability module 100 may use a binary system to characterize probability. For example, a probability module 100 may use a printability model to characterize probability as being either a first state (e.g., printed) or a second, opposite state (not printed). Accordingly, in certain embodiments, a printability model may define a threshold 164. A threshold 164 may, in turn, define a dividing line within a range 162. All probabilities falling on one side of the threshold 164 may be characterized as being or pertaining to one state (e.g., be set to one of “1” or “0”), while all probabilities falling on the other side of the threshold 164 may be characterized as being or pertaining to another, opposite state (e.g., be set to the other of “1” or “0”). All probabilities falling directly on the threshold 164 may be assigned to one of the two states per a present rule.

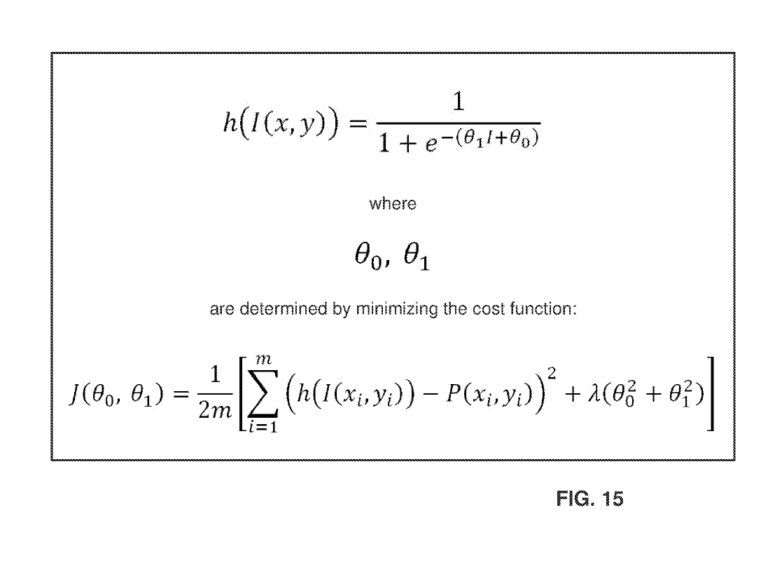

Referring to FIG. 15, in certain embodiments, a probability module 100 in accordance with the present invention may have or utilize an optimization scheme to generate a printability model. In such embodiments, a probability module 100 may use machine learning algorithms such as logistic regression, support vector machines, neural networks, or the like. For example, when a sampling window for each sub-resolution assist feature 42 comprises a single point (i.e., a single sample 158) and logistic regression is used, the creation of printability model may proceed as illustrated.

In the illustrations, I(x, y) may represent the intensity sampled (e.g., by a sampling module 98) at the point x, y. The function h(I(x, y)) may represent a function evaluated at I(x, y). Once optimization of the printability model has been completed, h(I(x, y)) may equal a probability that a sub-resolution assist feature 42 corresponding to the location x, y will print. The two thetas (e.g., θ₀ and θ₁) may represent parameters whose values are determined in the process of optimizing the printability model. The value m may represent the number of inspection sites, which is typically a few hundred. Lambda may represent a value selected to assist the system in reaching a solution.

The function P(x, y) may be an inspection value (e.g., a value selected by a human inspector based on an inspection of an actual etched substrate 16) indicating whether a sub-resolution assist feature printed at the point x, y. P(x, y) may be set to “1” when a sub-resolution assist feature 42 prints and “0” when the sub-resolution assist feature 42 does not print. In certain embodiments or situations, it may not be possible for a human inspector to determine whether a sub-resolution assist feature 42 printed. For example, for the same pattern 12 at different locations, a sub-resolution assist feature 42 may print at one location, but not in another location. In such cases, P(x, y) may be assigned a value between “0” and “1” to reflect the probability of printing.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer implemented method for optimizing one or more sub-resolution assist features for use in a photolithographic process, the method comprising:
incorporating, by a computer system, a sub-resolution assist feature within a virtual photomask;
modeling, by the computer system, performance of the virtual photomask by producing a virtual print from the virtual photomask;
selecting, by the computer system, one or more locations on the virtual print as being characteristic of a printability of the sub-resolution assist feature;
sampling, by the computer system, an intensity of the one or more locations;
assigning, by the computer system based on the intensity of the one or more locations, a probability of printing corresponding to the sub-resolution assist feature; and
adjusting, by the computer system, a physical characteristic of the sub-resolution assist feature within the virtual photomask to reduce the probability.

2. The method of claim 1, further comprising providing, by the sub-resolution assist feature during the modeling, an increased process window associated with the virtual photomask.

3. The method of claim 2, wherein the providing the process window comprises providing as least one of an increased depth-of-focus and an increased exposure latitude associated with the virtual photomask.

4. The method of claim 3, wherein the sub-resolution assist feature comprises a scattering bar.

5. The method of claim 4, wherein the physical characteristic comprises at least one of a location and size of the scattering bar.

6. The method of claim 5, wherein the assigning the probability comprises selecting between a first state and a second state, opposite to the first state.

7. The method of claim 6, wherein the first state corresponds to the scattering bar printing and the second state corresponds to the scattering bar not printing.

8. The method of claim 7, further comprising repeating the modeling, selecting, sampling, and assigning using with the scattering bar as adjusted.

9. The method of claim 8, wherein the repeating comprises iterating to optimize a reduction to the probability.

10. The method of claim 9, further comprising incorporating a plurality of scattering bars within the virtual photomask.

11. The method of claim 10, wherein the repeating comprises iterating to optimize a reduction to a probability of printing for each of the plurality of scattering bars.

12. The method of claim 1, wherein the assigning the probability comprises selecting between a first state and a second state, opposite to the first state.

13. The method of claim 12, wherein the first state corresponds to the scattering bar printing and the second state corresponds to the scattering bar not printing.

14. The method of claim 1, wherein the physical characteristic comprises at least one of a location and size of the sub-resolution assist feature.

15. The method of claim 14, further comprising repeating the modeling, selecting, sampling, and assigning using with the sub-resolution assist feature as adjusted.

16. A computer implemented method for optimizing at least one of a location and size of a sub-resolution assist feature, the method comprising:
generating, by a computer system, a virtual photomask comprising a main feature and a sub-resolution assist feature;
modeling, by the computer system, performance of the virtual photomask by producing a virtual print from the virtual photomask;
measuring, by the computer system from the virtual print, a critical dimension corresponding to the main feature;
collecting, by the computer system form the virtual print, at least one intensity value corresponding to the sub-resolution assist feature;
assigning, by the computer system based on the at least one intensity value, a probability of printing to the sub-resolution assist feature;
iterating, by the computer system, the modeling, measuring, collecting and assigning;
using, by the computer system during the iterating, the critical dimension to optimize a shape of the main feature; and
using, by the computer system during the iterating, the probability to optimize at least one of a location and size of the sub-resolution assist feature.

17. The method of claim 16, wherein the using the probability to optimize comprises reducing the probability.

18. The method of claim 16, wherein the assigning the probability comprises selecting between a first state and a second state, opposite to the first state.

19. The method of claim 18, wherein the first state corresponds to the sub-resolution assist feature printing and the second state corresponds to the sub-resolution assist feature not printing.

20. An apparatus comprising:
a processor;
memory operable connected to the processor; and
the memory storing
a modeling programmed to predict a performance of a virtual photomask by producing a virtual print from the virtual photomask,
a measuring module programmed to measure, from the virtual print, a critical dimension corresponding to one or more main features of the virtual photomask,
a sampling module programmed to collect, form the virtual print, at least one intensity value corresponding to each of one or more sub-resolution assist features of the virtual photomask,
a probability module programmed to assign, based on one or more intensity values collected by the sampling module, a probability of printing for each of the one or more sub-resolution assist features,
an optimization module programmed use critical dimensions measured by the measuring module to optimize a shape of each main feature of the one or more main features, and
the optimization module further programmed to use probabilities assigned by the probability module to optimize at least one of a location and size of each of the one or more sub-resolution assist features.
